(19) United States
(12) Patent Application Publication
(10) Pub. No.: US 2012/0116860 A1
(43) Pub. Date: May 10, 2012

(54) PAYMENT DETERMINATION IN AUCTIONS

(75) Inventors: Aleksandrs Slivkins, San Jose, CA (US); Moshe Babaioff, Sunnyvale, CA (US); Robert D. Kleinberg, Ithaca, NY (US)

(73) Assignee: Microsoft Corporation, Redmond, WA (US)

(21) Appl. No.: 12/939,192

(22) Filed: Nov. 4, 2010

(51) Int. Cl. G06Q 30/00

(52) U.S. Cl. 705/14.34; 705/26.3

(57) ABSTRACT

An auction may include a general schema to create incentives for those agents or bidders to bid on items at auction truthfully. The schema may implement any allocation rule, including a monotone allocation rule. The schema may provide for accepting bids from bidders, transforming the bids in a manner appropriate to the item being auctioned, and applying the allocation rule on the transformed bid. The schema may further provide for providing a rebate or payment back to the bidders.

### BACKGROUND

Bidders in an auction may be self-interested and act in their own best interests (e.g., to maximize their own utility). For example, only a bidder knows the extent of his willingness to pay for goods on auction. The auctioneer, however, may not know the extent of the bidder's willingness to pay, thereby potentially inviting the bidders to attempt to manipulate the auction and obtain goods for some amount less than the bidders' true intrinsic valuation. For example, a good may be worth $100 to a first bidder. The first bidder, however, may attempt to optimize its decisions based on existing knowledge (e.g., multi-armed bandit) or may, by whatever methodology, conclude that the value of the good to the next-highest bidder is only $90. Thus, the first bidder may bid $91 (even though the value to him is higher) to outbid the next highest bidder.

A goal of an auctioneer, however, may be to build an auction with high global performance that is also “incentive-compatible”, i.e., combats untruthful bidding. These two goals may be hard to achieve simultaneously. An auctioneer may carefully design the allocation rule (i.e., the rule that governs which bidders win the goods) as well as the payment rule (i.e., the rule that governs how much each bidder pays for the goods). Through careful design of these two rules, an auctioneer may promote an auction having high economic efficiency and a degree of bidder trustworthiness.

In some settings, an incentive-compatible auction may be created through use of a monotone allocation rule (i.e., a rule such that a bidder cannot lose by increasing his bid while all other bids are fixed). But determining the costs of the goods so as to ensure incentive-compatibility might be computationally expensive or even impossible because of a lack of information. Therefore, the payment rule may be difficult to determine.

Thus, there is a need for an auction methodology and system with allocation and payment rules that disincentives the self-interested bidder from bidding below his perceived intrinsic value and enables the auctioneer to maximize economic efficiency in the auction.

### SUMMARY

An auction may include a general schema to create incentives for those agents or bidders to bid on items at auction truthfully. The schema may implement a monotone allocation rule. The schema may provide for accepting bids from bidders, transforming the bids in a manner appropriate to the item being auctioned, and applying the allocation rule on the transformed bids. The schema may further compute amounts charged or rebated to bidders.

In an implementation, the auction may be a “pay-per-click” auction where advertisement slots of, for example, a web search engine are auctioned. The bidders may bid to have their respective advertisement placed on a results page provided by the search engine, and bid on the maximal price they are willing to pay each time a third-party computer user clicks on the bidders' advertisement. Each bid may, with a predetermined probability, be transformed to a transformed bid amount. The transformed bid amount may be less than the original bid. The allocation rule may be applied to this transformed bid to determine the winners at auction. A rebate may be provided to the bidders. The amount of rebate may be the quotient of the transformed bid divided by the predetermined probability.

In an implementation, the auction may be for services (e.g., accounting, legal, lawn services, etc.) provided by the bidders that a seller may desire. Each bid may, with a predetermined probability, be transformed to a transformed bid amount. The transformed bid amount may be greater than the original bid. The allocation rule may be applied to the transformed bid to determine the winners at auction (e.g., those bidders selected to perform the desired services for the seller). A rebate may be provided.

In an implementation, a bid for an item may be transformed by drawing a value uniformly at random within a predefined range. The value drawn may be multiplied times the original bid, resulting in the transformed bid. Recursive transformation may be performed such that the transformed bid is again transformed. If the bid is to be transformed again, then a new value is drawn uniformly at random within a new predefined range that is based on the transformed bid. This new value is multiplied by the previously transformed bid (which is now the current bid), and the allocation rule is applied to the resulting product.

In an implementation, the resulting and randomly transformed bids and/or rebates may create an incentive for bidders to bid truthfully at auction and may create a disincentive for untruthful bidding practices.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is block diagram of an implementation of a system that may be used to provide payment determination in auctions;

FIG. 2 is an operational flow of an implementation of a method of providing payment determination in auctions;

FIG. 3 is an operational flow of an implementation of a method for determining if a bid should be transformed;

FIG. 4 is an operational flow of an implementation of a method for transforming a bid;

FIG. 5 is an operational flow of an implementation of a method for determining a rebate amount; and

FIG. 6 shows an exemplary computing environment.

### DETAILED DESCRIPTION

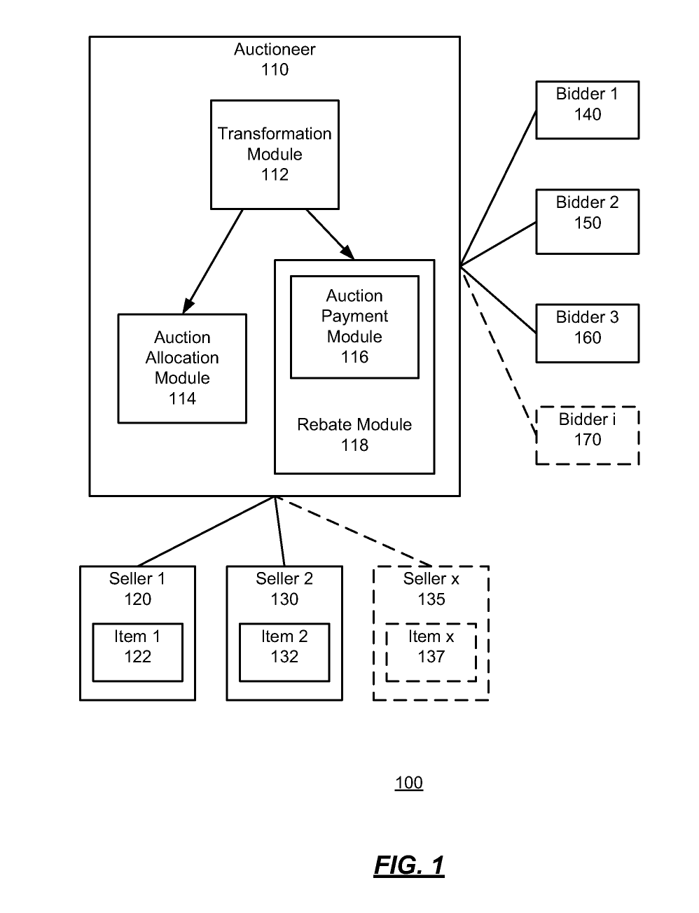

FIG. 1 shows an exemplary system 100 for implicit payment determination in auctions. The system 100 may include an auctioneer 110, bidders 140, 150, 160, 170 and sellers 120, 130, 135. There may be any number x of sellers 120, 130, 135. Each of the sellers 120, 130, 135 may be anybody or entity such as, for example purposes only, any individual, company, corporation, partnership, business, store, retailer, advertiser, or entity, including any entity hosting, operating, or otherwise associated with, or having authority to auction, advertisement space or slots on a website or web search engine, etc. Further, sellers 120, 130, 135 may include anybody or entity that may seek, want, or use any service from anybody.

The items 122, 132, 137 being auctioned by the sellers 120, 130, 135 may be, for example purposes only, any manufacture, composition of matter, apparatus, system, process, method, service, advertisement, advertisement space, advertisement space including an advertisement slot associated with a web page or web search engine, or anything else that can be sold, licensed, auctioned, used or otherwise exchanged for value or consideration. Items also could be any need for any service that may be provided by the bidders.

The bidders 140, 150, 160, 170 may be anybody or entity, such as anybody or entity interested in participating in an auction, obtaining items such as items 122, 132, 137 or providing services called for by items 122, 132, 137. While four bidders 140, 150, 160, 170 are shown for example purposes, there may be any number i of bidders 140, 150, 160, 170.

The auctioneer 110 may be anybody or entity providing auction services. The auctioneer 110 may be distinct from the sellers 120, 130, 135 and/or the bidders 140, 150, 160, 170. Alternatively, the auctioneer 110 may be the same entity as one or more sellers 120, 130, 135 and/or one or more bidders 140, 150, 160, 170.

The auctioneer 110 may be capable of communicating with the bidders 140, 150, 160, 170 and/or with the sellers 120, 130, 135. Such communication, for example, may be facilitated by, for example, representatives or agents of the bidders 140, 150, 160, 170 and/or the sellers 120, 130, 135 meeting at a location of an agent of the auctioneer 110. Alternatively, the auctioneer 110 may communicate with one or more of the sellers 120, 130, 135 and bidders 140, 150, 160, 170 through any network such as, for example, the Internet, a wide area network, a local area network, a public telephone switching network, cellular network, or any combination of these or any other type of network.

The auctioneer 110 be an auctioneer module and may include a transformation module 112, an auction allocation module 114, an auction payment module 116, and a rebate module 118. In an implementation, the rebate module 118 may be comprised within the auction payment module 116. All of the modules 112, 114, 116, 118 may be in communication with, or capable of communicating with, any other module 112, 114, 116, 118 of the auctioneer 110. The auctioneer 110 may enable the bidders 140, 150, 160, 170 to bid on, and attempt to purchase, license, rent, use, or otherwise obtain or be provided, or provide services called for by, the items 122, 132, 137 being offered for auction by sellers 120, 130, 135. The auctioneer 110 may solicit bids from the bidders 140, 150, 160, 170 for the items 122, 132, 137. After receiving bids, the auction allocation module 114 may apply one or more allocation rules to determine whether one or more of the bidders 140, 150, 160, 170 should be provided one or more of the items 122, 132, 137. The allocation rule may comprise, for example, a “monotone” rule. An allocation rule may be monotone if increasing a bidder's bid while keeping all other bids the same does not decrease that bidder's allocation. The allocation rule may comprise any other allocation rule as well. The auction allocation module 114 may implement any auction allocation. For example purposes only, the auction allocation module 114 may implement the auction allocation of a Vickrey auction, Vickrey-Clarke-Groves (VCG) auction, a generalized second price-auction (GSP), etc. These specific auction techniques are offered by way of example and do not in any way limit embodiments or implementations. Further, the auction allocation rule may be a “single-parameter domain” that is capable of describing valuations by bidders 140, 150, 160, 170 of the items 122, 132, 137 with a single number.

The transformation module 112 of the auctioneer 110 may determine whether a bidder's bid should be transformed and, if so, determine the value of any transformed bid. The auction payment module 116 may assign payments required by bidders 140, 150, 160, 170 for items 122, 132, 137. The rebate module 118 may determine the amount, if any, of a rebate that should be provided to the bidder. The auction payment module 116 may take the rebate amount into account when determining the payment(s) (i.e., may subtract the rebate amount from an initially determined payment amount to result in the payment amount to be charged to the bidder). In an implementation, if the bid is transformed, then a rebate amount may be determined and used in the determination of the payment amount to be charged to the bidder. In an implementation, the rebate amount is determined implicitly, using random numbers, such that the correct payment amount is charged on average to the bidder. In an implementation, if the bid is not transformed (i.e., untransformed), then the rebate amount is zero (i.e., the bidder receives no rebate, such that no rebate amount is used in determining the payment amount to be charged to the bidder).

The transformation module 112 may transform bids received from one or more bidders 140, 150, 160, 170 with a predetermined probability μ. The value of μ may be determined or set by the auctioneer 110, for example. An example value of μ is 1%, for example, though any value may be used depending on the implementation. With a probability μ %, the transformation module 112 may transform the bid of each of the bidders 140, 150, 160, 170. Such a transformation may be performed with respect to one of the bidders 140, 150, 160, 170 irrespective of whether a bid from any other bidder is transformed.

With a probability of 100%-μ %, however, the transformation module 112 may determine that a bidder's bid remains untransformed. The auction allocation module 114 then may execute the allocation rule on the resulting bids, some of which may be transformed bids (if transformed) or the original bids (if not transformed). When the allocation module 116 has determined the winner or winners of the bid-upon item(s), such as the items 122, 132, 137, then the auction payment module 116 may determine the amount of money to be exchanged (i.e., payment amount) for the item 122, 132, 137. In the event that the bid is transformed, then the payment amount (i.e., the amount of money to be exchanged between the bidders 140, 150, 160, 170 and the sellers 120, 130, 135) may be equal to the transformed bid. Thus, the winner is charged his bid (per item) if the bid is untransformed, and the winner is charged the transformed bid taking into account the rebate amount (i.e., the transformed bid minus the rebate amount) if the bid is transformed. If multiple items are being sold, then all payments are per item. Of course, any auction payment rule may be implemented in alternative embodiments whether the bid is transformed or not.

More particularly, in the event that the bid is transformed, the rebate module 118 may determine a rebate amount to be incorporated into the payment amount to be charged to the each bidder whose bid was transformed. In embodiments, this rebate amount may be equal to the quotient of the transformed bid divided by the probability μ used to determine if bids should be transformed.

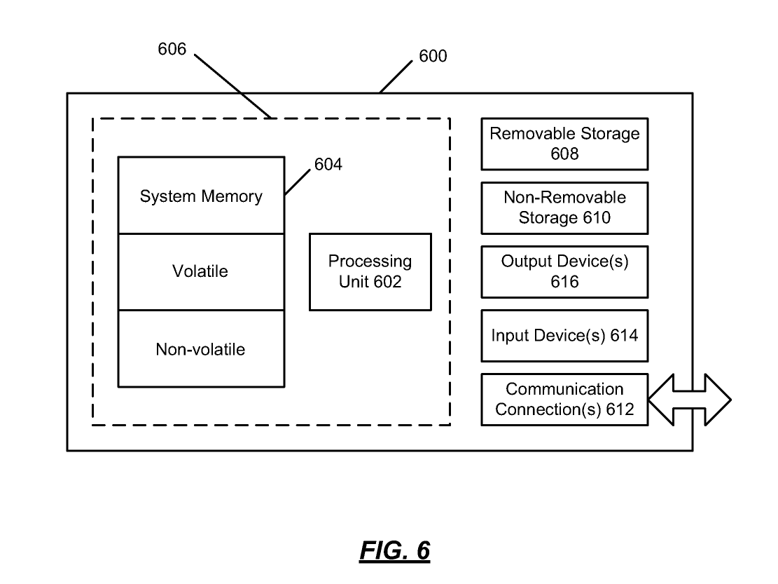

In one example embodiment, the auctioneer 110 may be facilitating “pay-per-click auctions,” which may be an auction for selling items 122, 132, 137 such as advertisement slots by a web search engine. According to an embodiment, the sellers 120, 130, 135 may be configured to provide data and media content such as web pages and search engine result pages to client computers that are searching on the Internet, for example. As part of those results pages, the sellers 120, 130, 135 may provide advertisements associated with the subject matter of the results pages to user computers. Thus, the sellers 120, 130, 135 may comprise, or be comprised within, a computing environment such as that described with respect to FIG. 6. Similarly, the auctioneer 110, the transformation module 112, the auction allocation module 114, the auction payment module 116, and the rebate module 118 may comprise, or be comprised within, one or more computing devices, such as the computing device 600 of FIG. 6.

The sellers 120, 130, 135 may sell space or slots for advertisements on the search engine result pages by auctioning the slots using the auctioneer 110. In such auctions, the bidders 140, 150, 160, 170 may be advertisers or entities desiring to advertise who submit bids for their advertisements to be shown in the slots.

The auctioneer 110 may execute the auction allocation module 114 to allocate advertisements to available slots, and the auction payment module 116 may assign payments. Bidders 140, 150, 160, 170 may derive value from clicks on their respective advertisements provided on web search engine result pages. The sellers 120, 130, 135 of the advertisement slots may charge the bidders 140, 150, 160, 170 (through use of the auctioneer 110) for each click of the advertisement on their pages. Thus, the bidders 140, 150, 160, 170 may be charged when their respective advertisement is clicked.

Some implementations may address the problem of learning “click-through-rates” in a pay-per-click auction without compromising truthfulness or efficiency. Specifically, with the auction allocation module 114 implementing an allocation rule, the embodiment addresses challenges in computing “truthful payments” by attempting to create an incentive for bidder advertisers 140, 150, 160, 170 to submit truthful bids.

Jointly, the allocation rule executed by the auction allocation module 114 and the payment rule implemented by the auction payment module 116 may constitute a mechanism with at least two goals. One goal may be to encourage bidder-advertisers 140, 150, 160, 170 to submit truthful bids (e.g., the true value to them of each click of their respective advertisement). The second goal, assuming the bids are truthful, may be to provide an efficient allocation in terms of, for example, total welfare (the sum of “utilities” of all participants, including the auctioneer himself). Successful implementation of such a mechanism may benefit from knowledge of the click-through rate for each submitted advertisement—that is, the rate at which the advertisement is clicked by a user. Because click-through-rates, however, may not be known, they may need to be estimated or learned through, for example, experimentation using the same allocation rule applied by the auction allocation module 114. A problem, however, with such experimentation may be that it creates an incentive for bidder-advertisers to submit untruthful bids in an attempt to manipulate the process of learning or estimating that in turn may result in inefficient allocations.

In some embodiments, a general schema may be successfully implemented using any allocation rule, including allocation rules that learn optimally without requiring knowledge of Bayesian priors for click-through-rates. In some embodiments, regardless of the allocation rule, the bidders 140, 150, 160, 170 may have less, little, or no incentive to be untruthful in their bids for the items 122, 132, 137. The disincentive to bid untruthfully may be caused by the injection of an element of randomness into the auction process. This randomness may be injected by the use of the transformation module 112 and/or the rebate module 118 as described herein.

The transformation module 112 may determine whether bids received from one or more of the bidders 140, 150, 160, 170 for items 122, 132, 137 should be transformed into a different bid referred to herein as a transformed bid. To make this determination, the transformation module 112 may apply a low-probability transformation of bids before running the allocation rule. The auctioneer 110, or one or more modules 112, 114, 116, 118 of the auctioneer 110, may also determine a charge-per-click depending on whether the corresponding bid has been modified or transformed.

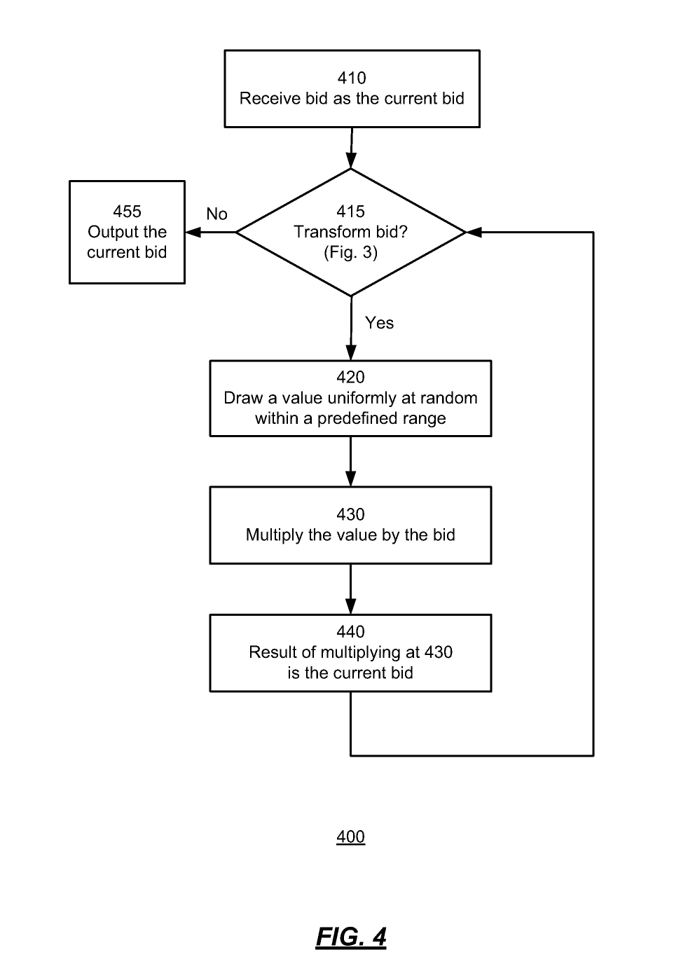

The auctioneer 110 may further operate an iterative allocation rule that uses previous click information to determine appropriate allocations in later steps. For example, the auctioneer 110 may collect respective bids from bidders 140, 150, 160, 170 once but the allocation module 114 may proceed over many iterations as described further herein (e.g., with respect to the method 400 of FIG. 4). Next, after receiving a bid from each bidder, the transformation module 112 may determine, for each bidder 140, 150, 160, 170, whether to transform that bidder's bid. To do so, the auctioneer 110 or the transformation module 112 selects a probability μ % to be applied independently for each bidder 140, 150, 160, 170 in the determination. Thus, with a probability of μ %, the transformation module 112 may transform each bidder's bid. With a probability of 100%-μ %, each bidder's bid remains untransformed. This determination is made for each bidder 140, 150, 160, 170 independent of the other bidders 140, 150, 160, 170 such that, for example, the bid from bidder 140 may be transformed while the bids from bidders 150, 160, 170 remain untransformed.

If the auctioneer 110 or the transformation module 112 determines that a bidder's bid is to be transformed, then the transformation module 112 transforms the bid into the transformed bid. To do so, the auctioneer 110 or the transformation module 112 may draw a value γ uniformly at random from within a predetermined range or set. For example, the value γ may be drawn from a range of 0 to 1. The transformation module 112 may then multiply this value γ times the bid. The product resulting from this multiplication may be designated as the transformed bid (or the current bid). In an implementation, a recursive process is used on the transformed bid, as described further herein. For a bid that is transformed, after the recursive process ends, resulting in a transformed bid (i.e., a final current bid), the auction allocation module 114 then uses the transformed bid (the final current bid) when determining the allocation according to the allocation rule.

Thus, the auctioneer 110 may perform a recursive process with the transformed bids. For example, if the bid from bidder 160 is transformed, then this transformed bid is used in subsequent iterations. Thus, in the event that bidder 160′s bid is to be transformed a second time, then the previously-transformed bid is used in determining the next transformed-bid value to be used in the allocation. An example recursion process is described in more detail with respect to FIG. 4.

The transformation module 112 or the auction payment module 116 may then send the current bids from each bidder (i.e., the original bid received from the bidder (if the bid was not transformed) or the transformed bid) to the auction allocation module 114. The auction allocation module 114 may execute the allocation rule to determine those bidders 140, 150, 160, 170 that will be provided with the bid-upon item or items 122, 132, 137 (e.g., the advertisement slots on the result pages provided by the web search engine).

After the bidders 140, 150, 160, 170 are identified as the winner of the item or items 122, 132, 137, the auction payment module 116 may assign the appropriate payment to be made by the winning bidder(s) 140, 150, 160. This amount may be the original bid amount or the transformed bid amount (taking into account a rebate amount if applicable) if any bid was transformed.

In an implementation, the rebate module 118 of the auction payment module 116 may determine and assign a rebate amount associated with one or more of the winning bidders. The rebate may be assigned each time the transformation module 112 transforms a bid or it may be assigned at some other interval or time in alternative embodiments.

The rebate module 118 may use any method to determine an amount of a rebate to be assigned to one or more of the bidders 140, 150, 160, 170. In one embodiment, the rebate may be determined by dividing the transformed bid amount by the probability μ implemented by the transformation module 112 when determining whether or not to transform a bid. Thus, in this embodiment, the lower the value of the probability μ, the lower the probability of transforming a bid. Also in this embodiment, the lower the value of the probability μ, the larger the rebate amount. Thus, in this embodiment, bidders 140, 150, 160, 170 would be assigned a payment larger than the original bid. In implementations such as in pay-per-click auctions, however, because of a relatively high frequency of bidding on advertisement slots, and because rebates may be provided with a low probability, the encouragement of truthful bidding may offset the payments to bidders. That is, the auctioneer 110 and/or the sellers 120, 130, 135 may recognize that, on average, the probability of a rebate is offset by the benefit of achieving truthful bids from bidders 140, 150, 160, 170.

Thus, in embodiments, truthful bidding may be achieved based on the randomness injected through the probability μ of transformation, either alone or in combination with the rebate. Further, in implementations, each bidder 140, 150, 160 may pay at most its original bid for the bid-upon items 122, 132, 137. The allocation may coincide with the one from the original allocation rule with probability (1-μ)ⁿ, where n is the number of bidders 140, 150, 160, 170. Further, embodiments may be efficiently and successfully implemented with any monotone allocation rule.

In an alternative embodiment, the bidders 140, 150, 160, 170 may be, for example, entities providing services such as, for example, accounting services, legal services, lawn services, etc. Thus, the sellers 120, 130, 135 may not be interested in selling the items 122, 132, 137 but instead the items may be services that the sellers 120, 130, 135 want and are willing to pay for. In this alternative embodiment, the sellers 120, 130, 135 may be interested in obtaining the services for the best price, for example, and therefore the bidders 140, 150, 160, 170 may be attempting to win an auction not by bidding higher with respect to other bidders, as in the previous pay-per-click example embodiment, but instead by attempting to bid lower.

In such an embodiment, the transformation module 112 may transform one or more bids based on some predetermined probability. The transformed bids (if any), however, may be larger than the original bids. For each of the bidder's bids that is to be transformed, the transformation module 112 may draw the value γ uniformly at random from within a predetermined range or set. For example, the value γ may be drawn from a range of 1 to 2. The transformation module 112 may multiply this value γ times the bidder's bid and the product resulting from this multiplication may be designated as the transformed bid. Thus, in some embodiments and depending on the range or set from which y is drawn, the transformed bid may be more than the original bids. Of course, in alternative embodiments, the transformed bid may be less than the original bid.

The transformation module 112 or the auction payment module 116 may send the original bids received from the bidders (if the bids were not transformed) and/or any transformed bids to the auction allocation module 114. The auction allocation module 114 may then execute the allocation rule to determine those bidders 140, 150, 160, 170 that won the auction and that will be able to fulfill the services needs (i.e., items 122, 132, 137) of the sellers 120, 130, 135.

After the bidders are identified as the winner of the auction, the auction payment module 116 may assign the value for the bid-upon services 122, 132. Such value may be equal to the original bid or to the transformed bid (taking into account a rebate amount).

After the auction allocation module 114 has determined the identity of the winning bidders, the rebate module 118 of the auction payment module 116 may determine a rebate amount to be provided to one or more of the winning bidders.

The rebate module 118 may use any method to determine a value of a rebate to be assigned to one or more of the bidders 140, 150, 160, 170. In one embodiment, the rebate per item may be determined by dividing either the original bid amount or the transformed bid amount by the probability μ % implemented by the transformation module 112 when determining whether or not to transform a bid. Thus, in this embodiment, the lower the value of the probability μ %, the lower the probability of transforming a bid. Also in this embodiment, the lower the value of the probability μ %, the larger the rebate value.

The solution presented in embodiments may be applicable to, for example, any single-parameter domain where valuation of an item such as items 122, 132, 137 may be described by a single number (e.g., how much each bidder 140, 150, 160 may be willing to pay for an item such as the item 122, 132). For example, it may present the right incentives for truthfully reporting edge costs in a “shortest path auction” problem in which the auction mechanism (e.g., allocation rule and payment rule) may need to buy a path in a network with edges controlled by selfish agents with privately known costs.

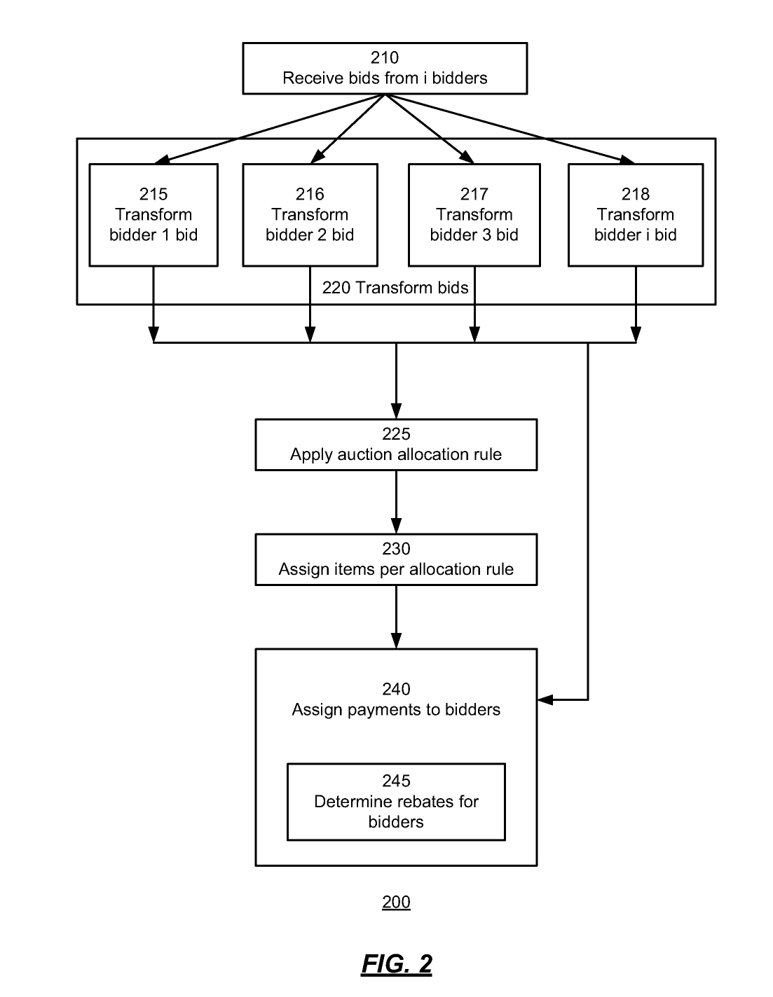

FIG. 2 shows an operational flow of a method 200 of payment computation in auctions. The method may commence at 210 by receiving respective bids from bidders 1, 2, 3 and i. The bids may be for an item being sold, etc., by a seller for advertising space such as an advertisement slot on a search engine's results page, or for providing a service requested of a “seller” or person requesting such a service, or anything else.

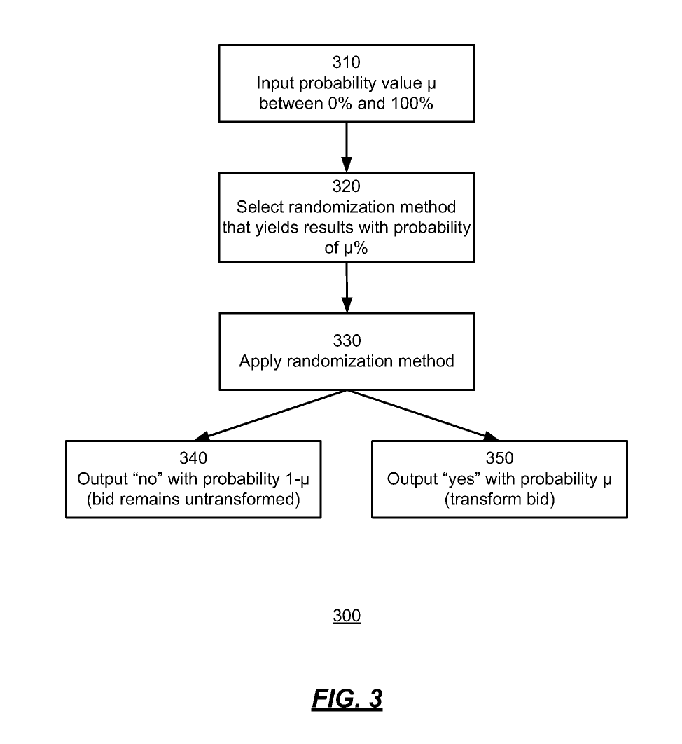

At 220, each bid is transformed into a current bid. More particularly, the bid received from bidder 1 is transformed into a current bid at 215, the bid received from bidder 2 is transformed at 216, the bid received from bidder 3 is transformed at 217, and the bid received from bidder i is transformed at 218. In an implementation, the current bid may be the transformed bid (the bid resulting from transforming the original bid into a different value) or the original bid (the untransformed bid, which is the original bid that is not transformed or transformed into the same original value). The current bid is set to the original bid at 220 if it is determined that the bid received from the bidder is not to be transformed into a different value bid, as described further herein. Thus, in an implementation, transforming the bid may comprise determining whether or not to transform the bid or leave it untransformed. FIG. 3 describes an example implementation for determining if a bid should be transformed into another bid or if the bid should remain untransformed (e.g., transformed into a current bid that equals the original bid). For those bids that are determined to be transformed into a different value, FIG. 4 describes an example implementation for transforming the bid using a recursive process.

After each bid is transformed to a current value that is either a different value than its original value or to its original value (i.e., remaining untransformed) at 220, then at 225, an auction allocation rule is applied to the current bids to determine the winner of the item. The current bids of the bidders, as determined at 220, may be provided to the auction allocation rule as a vector, for example. The auction allocation rule may use the vector of the bids to determine the allocation of the items.

At 230, items may be assigned to one or more bidders 1, 2, 3 and i based on the allocation rule applied at 225. For any bidder 1, 2, 3, i who has been assigned the auctioned item, a payment value to be assigned for the bid-upon item to each of the winning bidders 1, 2, 3, i may be determined at 240, using both the current bids determined at 220 and the output of 230. For each bidder 1, 2, 3, i whose bid was transformed, this payment value may be equal to, for example, the amount of the transformed bid taking into account any rebate amount determined at 245. For each bidder 1, 2, 3, i whose bid remained untransformed, this value may be a different amount such as, for example, the untransformed amount originally bid by that bidder, or any other amount.

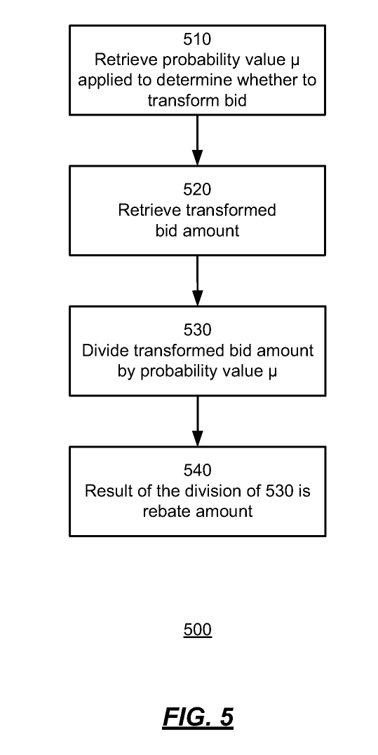

At 245, a rebate amount may be determined. Such an amount may be assigned for all bidders, for those whose bids were transformed, and/or for those whose bids remained untransformed. FIG. 5 provides an example implementation for determining a rebate amount.

FIG. 3 is an operational flow of an implementation of a method 300 for determining if a bid from each bidder should be transformed to a different value or transformed to its original value (i.e., remain untransformed). The method depicted in 300 is one implementation of a method for determining if a bid should be transformed. Of course, alternative implementations may use any other method for determining if a bid should be transformed to a different value or should remain untransformed.

At 310, a probability value μ between 0% and 100% may be selected. At 320, a method may be selected to implement the selected probability value such that the selected method yields results with the probability of μ or μ % of the time. For example, while implementations may use a low probability, if the probability μ % is 50%, then a randomization method selected at 320 to implement this probability may be a coin flip.

At 330, the randomization method may be applied to determine if the bid is to be transformed to a different value. If the output of the randomization method is a “no”, at 340, which occurs with a probability of 1-μ (or 100%-μ %), the bid may remain untransformed, and the method 300 may be completed. On the other hand, if the output of the randomization method is a “yes”, at 350, which occurs with a probability of μ (or μ %), the bid may be transformed.

FIG. 4 is an operational flow of an implementation of a method 400 for transforming a bid. The method depicted in 400 is one implementation of a method for transforming a bid. Alternative implementations may use any other method for transforming a bid.

At 410, a bid is received from a bidder, as the current bid. A determination may be made at 415 to determine if the bid should be transformed to a different value or remain unchanged from its current value (which may be the original value if previously untransformed or which may be a transformed value if the bid had been previously transformed to a different value, as this is a recursive process). In an implementation, the method 300 of FIG. 3 may be used determine whether or not to transform the bid to a different value. If the determination at 415 is for the current bid to remain unchanged, then at 455, the value returned (e.g., to 220) is the current bid (i.e., the current bid is outputted).

If the current bid is to be transformed to a different value, then at 420, a value may be drawn uniformly at random within a predefined range. The range may be, for example, 0 to 1, 1 to 2, 0 to 2, or any other suitable range. In the event that bidders are attempting to buy an item from a seller, then the range may be established between 0 and 1, for example. If the bidders are offering services to a “seller” seeking to obtain the services, for example, the range may be from 1 to 2. Of course, implementations may use any range for any purpose.

At 430, the value drawn uniformly at random within the predetermined range may be multiplied by the current bid. At 440, the product resulting from the multiplication may be the transformed bid (the new current bid). This transformed bid may then be used provided back to 415 where it may be determined if the transformed bid (the new current bid) is to be transformed to a different value again or output (e.g., to 220) as the current value of the bid for that bidder.

Thus, in an embodiment, each bidder's bid is recursively used and previously transformed bids may be transformed again, according to the predetermined probability described with respect to FIG. 3.

FIG. 5 is an operational flow of an implementation of a method 500 for determining a rebate amount. The method depicted in 500 is one implementation of a method for determining a rebate amount. Of course, alternative implementations may use any other method for determining a rebate amount.

At 510, the probability value μ used to determine whether or not to transform a bid to a different value may be received or retrieved and at 520, the transformed bid amount may be retrieved. The transformed bid amount is divided by the probability value μ, at 530. The quotient resulting from the division is the rebate amount, at 540.

FIG. 6 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by device 600 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for determining a payment amount for an item at auction comprising:
receiving, at an auctioneer, a bid for the item from a bidder;
determining, at a transformation module of the auctioneer, whether to transform the bid into a transformed bid of a different value than the bid, based on a predetermined probability;
determining, at an auction payment module and a rebate module, an amount of money to be exchanged for the item, wherein the amount of money is determined based on the bid, on whether the bid was transformed into the transformed bid, and on a rebate amount.

2. The method of claim 1, wherein the amount of money to be exchanged is less than the bid.

3. The method of claim 1, wherein the rebate amount is based on whether the bid was transformed into the transformed bid of the different value than the bid.

4. The method of claim 1, further comprising applying an auction allocation rule to determine if at least one of the bid or the transformed bid results in the bidder winning the item.

5. The method of claim 1, wherein determining the rebate amount comprises determining a quotient of the transformed bid divided by the predetermined probability.

6. The method of claim 1, further comprising transforming the bid into the transformed bid.

7. The method of claim 6, wherein transforming the bid into the transformed bid comprises:
randomly selecting a multiplier; and
multiplying the multiplier by the bid, wherein a product resulting from the multiplying is the transformed bid.

8. The method of claim 7, wherein the bid to be transformed into the transformed bid was previously transformed.

9. The method of claim 1, wherein the auction comprises a pay-per-click auction.

10. The method of claim 9, wherein the item is an advertisement displayed on a web page.

11. The method of claim 1, wherein the item is a request for a service provided by the bidder.

12. A method for determining a payment amount for an item being sold in an auction comprising:
receiving, at an auctioneer, a plurality of bids for the item, each of the bids being received from an associated bidder of a plurality of bidders;
transforming, at a transformation module of the auctioneer, each of the bids into a transformed bid based upon a predetermined probability, wherein each transformed bid has a different value than the bid or has a same value as the bid, depending on the predetermined probability; and
applying, at an auction allocation module of the auctioneer, an auction allocation rule to determine the transformed bid and the associated bidder to receive the item.

13. The method of claim 12, further comprising determining a rebate amount for each transformed bid that has a different value than the associated bid.

14. The method of claim 13, wherein the rebate amount is equal to a quotient of the transformed bid divided by the predetermined probability.

15. The method of claim 12, wherein the auction comprises a pay-per-click auction.

16. The method of claim 15, wherein the items are each an advertisement displayed on a web page.

17. The method of claim 12, wherein the item is a request for a service provided by the bidders.

18. A system for determining an exchanged payment amount for an item at auction comprising:
at least one auction module adapted to receive a plurality of bids for the item from a plurality of bidders and to transform at least one of the plurality of bids, wherein the at least one module is further adapted to determine:
whether to transform each of the plurality of bids into a respective transformed bid based on a predetermined probability; and
the exchanged payment amount for the item based, at least in part, on a rebate amount associated with a respective transformed bid and on a value of the respective transformed bid; and
an auction allocation module in communication with the at least one module adapted to receive the plurality of bids for the item and any transformed bid, and apply an auction allocation rule to identify at least one winner of the item.

19. The system of claim 18, wherein the at least one auction module comprises at least one of a payment allocation module, a rebate module, or a transformation module.

20. The system of claim 18, wherein the at least one auction module determines the rebate amount by calculating a quotient of the transformed bid divided by a predetermined probability.
